(19) United States
(12) Patent Application Publication
(10) Pub. No.: US 2017/0122454 A1
(43) Pub. Date: May 4, 2017

(54) Electro-Hydraulic Actuator

(71) Applicant: Pentair Flow Services AG, Schaffhausen (CH)

(72) Inventors: Miguel Angel Baza Vazquez, Tlajomulco de Zuniga (MX); Humberto Jose Barillas Vidal, Guadalajara (MX)

(21) Appl. No.: 14/930,474

(22) Filed: Nov. 2, 2015

(51) Int. Cl. F16K 31/04; F16H 25/22; F15B 1/04; F15B 15/14

(52) U.S. Cl. CPC F16K 31/047; F15B 15/1447; F16H 25/2204; F15B 1/04

(57) ABSTRACT

Embodiments of the invention provide an electro-hydraulic actuator including an electric linear actuator, a double chamber hydraulic cylinder, and a hydraulic actuator. The double chamber hydraulic cylinder includes a double chamber piston coupled to the electric linear actuator and defining a first double chamber volume and a second double chamber volume. The hydraulic actuator includes a hydraulic actuator housing, a first rack piston, a second rack piston, a rack arranged between the first rack piston and the second rack piston, and a pinion engaged with the rack. A first hydraulic actuator volume is defined between the hydraulic actuator housing and the first rack piston in communication with the first double chamber volume, and a second hydraulic actuator volume is defined between the hydraulic actuator housing and the second rack piston in communication with the second double chamber volume.

### BACKGROUND

This disclosure relates to electro-hydraulic actuators for valves. In some installations in the oil and/or gas industry, it is sometimes desirable to implement fail-in-last position actuators onto process valves for affecting the flow of fluids such as oil or gas. In the event of primary power loss, a fail-in-last position actuator will maintain an associated valve in the current position. Typically, fail-in-last position actuators utilize pumped systems and solenoid controlled circuits to provide the desired functionality.

### BRIEF SUMMARY OF THE INVENTION

There exists a need for a simpler system that does not include a power consuming pump and control circuitry to provide a fail-in-last position actuator.

Some embodiments of the invention provide an electro-hydraulic actuator for actuating a valve. The electro-hydraulic actuator includes an electric linear actuator having an electric motor and a controller that controls the electric motor. A double chamber hydraulic cylinder includes a double chamber piston that is coupled to the electric linear actuator, and defines a first double chamber volume and a second double chamber volume. The position of the double chamber piston affects the relative volumes of the first double chamber volume and the second double chamber volume. A hydraulic actuator includes a hydraulic actuator housing, a first rack piston, a second rack piston, a rack arranged between the first rack piston and the second rack piston, and a pinion engaged with the rack. A first hydraulic actuator volume is defined between the hydraulic actuator housing and the first rack piston and is in communication with the first double chamber volume. A second hydraulic actuator volume is defined between the hydraulic actuator housing and the second rack piston and is in communication with the second double chamber volume.

Another embodiment of the invention provides a valve and actuator system that includes a valve and an electro-hydraulic actuator. The valve includes a quarter turn valve element moveable between an open position and a closed position. The electro-hydraulic actuator includes an electric linear actuator, a double chamber hydraulic cylinder having a double chamber piston coupled to the electric linear actuator, and a hydraulic actuator having a hydraulic actuator housing, a first rack piston, a second rack piston, a rack arranged between the first rack piston and the second rack piston, and a pinion engaged with the rack. Movement of the double chamber piston actuates the hydraulic actuator. The pinion is coupled to the valve to actuate the quarter turn valve element between the open position and the closed position.

Another embodiment of the invention provides a method of operating a valve with an electro-hydraulic actuator. The method includes controlling an electric motor with the controller, moving a linear actuator with the electric motor, moving a double chamber piston with the linear actuator, moving a rack with hydraulic fluid moved by the double chamber piston, rotating a pinion with the rack, and actuating the valve with the pinion.

### BRIEF DESCRIPTION OF DRAWINGS

FIG. 1 is a perspective view of an electro-hydraulic actuator according to one embodiment of the invention.

FIG. 2 is a front view of an electric actuator of the electro-hydraulic actuator of FIG. 1.

FIG. 3 is a right side view of the electric actuator of FIG. 2.

FIG. 4 is a schematic representation of the electro-hydraulic actuator of FIG. 1.

FIG. 5 is a perspective view of a hydraulic actuator of the electro-hydraulic actuator of FIG. 1.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

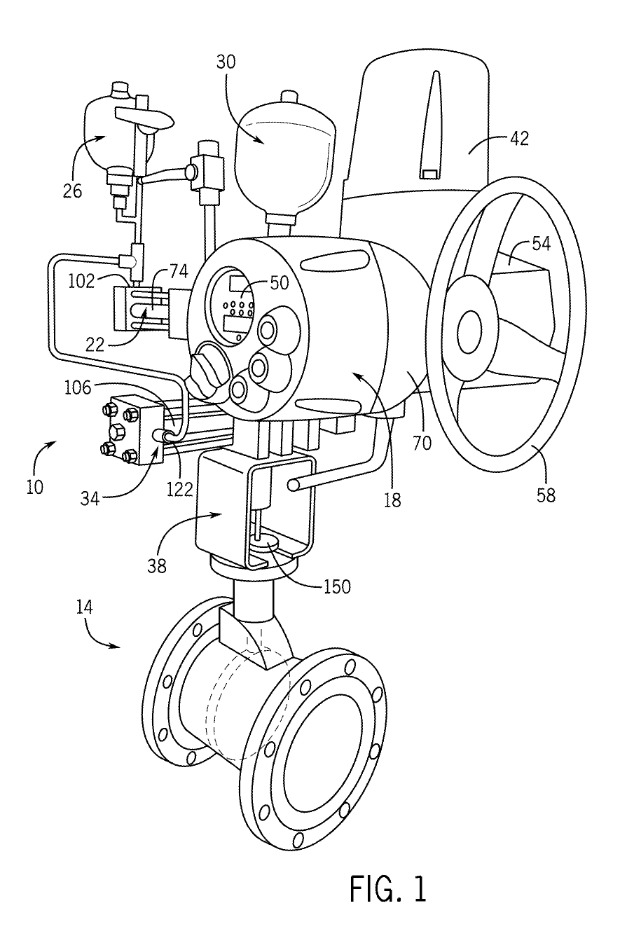

FIG. 1 illustrates an electro-hydraulic actuator 10 coupled to a valve 14. The electro-hydraulic actuator 10 includes an electric actuator 18, a double chamber hydraulic cylinder 22, a first accumulator 26, a second accumulator 30, a hydraulic actuator 34, and a coupling 38.

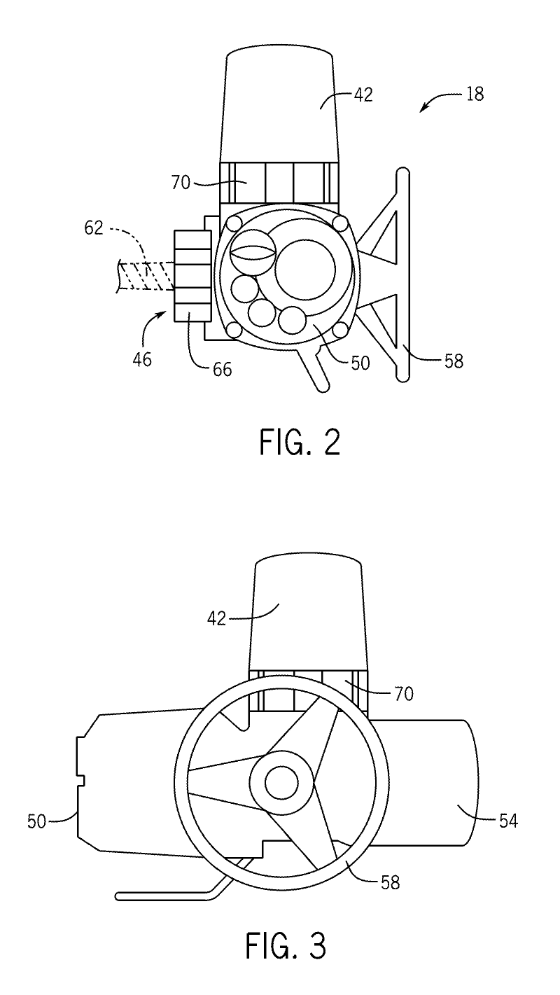

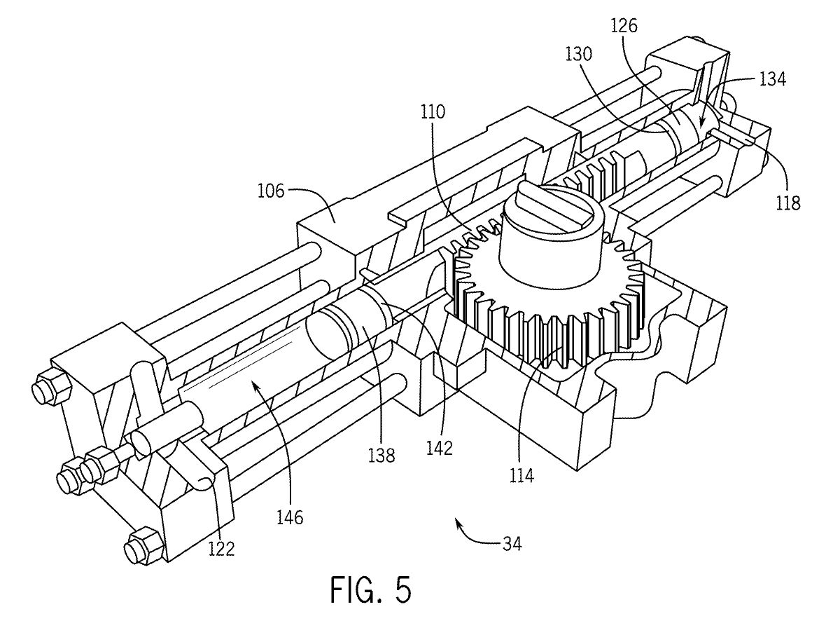

As shown in FIGS. 2 and 3, the electric actuator 18 includes an electric motor 42 coupled to a power screw assembly 46 (as shown in FIG. 5), a controller 50, a terminal connection 54, and a manual actuator in the form of a hand wheel 58. The power screw assembly 46 includes a threaded shaft 62 and a recirculating ball nut 66. The recirculating ball nut 66 may be driven by the electric motor 42 via a worm gear (not shown). The controller 50 is in communication with at least one valve position sensor (not shown), includes a user interface, provides wireless communication via Bluetooth™, and communicates with the Foundation Fieldbus protocol and/or other suitable protocols. The controller 50 selectively operates the electric motor 42 to rotate the recirculating ball nut 66 to effect linear motion of the threaded shaft 62. The terminal connection 54 provides electrical connection and communication of the electro-hydraulic actuator 10 with external networks and control systems. The hand wheel 58 can be used as a manual override to actuate the power screw assembly 46.

The electric actuator 18 integrates the electric motor 42, the controller 50, and all required communication functions in an explosion proof enclosure 70, with a local interface for local non-intrusive operation and configuration. Remote operation and configuration of the electric actuator 18 are also available via the Bluetooth™ wireless communication provided by the controller 50. Manual operation via the hand wheel 58 is provided in case of power failure. The low revolutions output of electric motor 42 is converted into linear movement of the threaded shaft 62 by the recirculating ball nut 66. The power screw assembly 46 with recirculating balls increases the mechanical efficiency and the usable lifetime of the electric actuator 18.

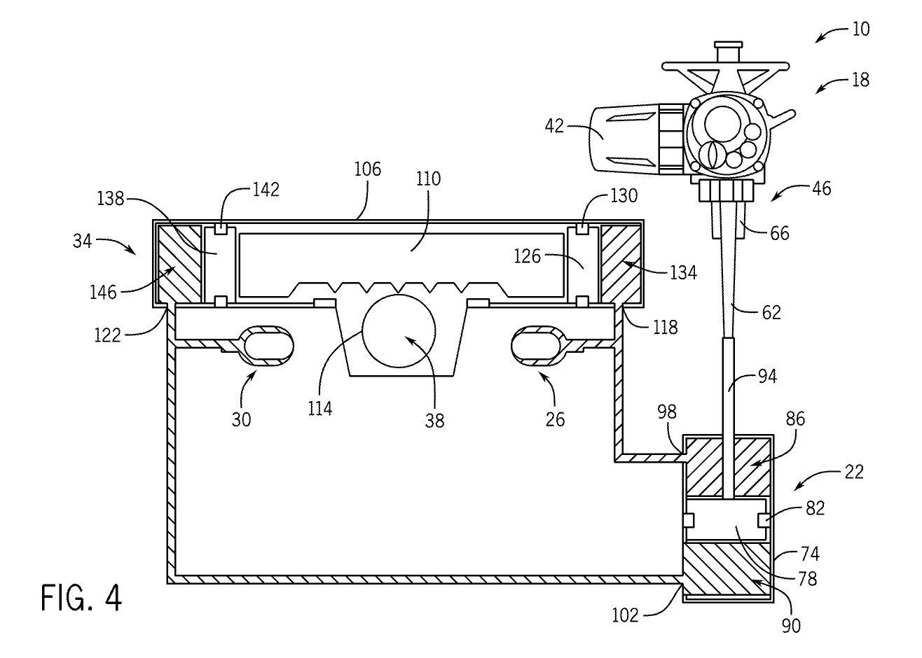

As shown in FIG. 4, the double chamber hydraulic cylinder 22 includes a double chamber housing 74 and a double chamber piston 78 arranged within the double chamber housing 74. The double chamber housing 74 may be directly attached (e.g., fastened) to the explosion proof enclosure 70 of the electric actuator 18, as shown, or may be coupled to the electric actuator with an intermediate coupling. The double chamber piston 78 seals against an inner surface of the double chamber housing 74 with a seal 82 and defines a first double chamber volume 86 on a first side of the double chamber piston 78 and a second double chamber volume 90 on a second side of the double chamber piston 78. In other words, the first double chamber volume 86 is defined within the double chamber hydraulic cylinder 22 between the double chamber housing 74 and the double chamber piston 78. The second double chamber volume 90 is defined within the double chamber hydraulic cylinder 22 between the double chamber housing 74 and the double chamber piston 78. The first double chamber volume 86 and the second double chamber volume 90 are positioned on opposing sides of the double chamber piston 78. Each of the first double chamber volume 86 and the second double chamber volume 90 defines a relative size that changes depending on the position of the double chamber piston 78 within the double chamber housing 74.

As further shown in FIG. 4, the double chamber piston 78 is coupled to the threaded shaft 62 of the power screw assembly 46 by a coupler 94 that is arranged to pass through the double chamber housing 74. The double chamber housing 74 includes a first double chamber port 98 in communication with the first double chamber volume 86, and a second double chamber port 102 in communication with the second double chamber volume 90. The double chamber piston 78 is movable within the double chamber housing 74 in response to movement of the threaded shaft 62 so that the first double chamber volume 86 and the second double chamber volume 90 change in response to movement of the double chamber piston 78. The change in size of the first double chamber volume 86 is inversely proportional to the change in size of the second double chamber volume 90 with movement of the double chamber piston 78 within the double chamber housing 74.

The first accumulator 26 is in fluid communication with the first double chamber volume 86 via the first double chamber port 98, and the second accumulator 30 is in fluid communication with the second double chamber volume 90 via the second double chamber port 102. The first accumulator 26 and the second accumulator 30 may be substantially the same and in one embodiment are bladder type accumulators. The first accumulator 26 and the second accumulator 30 compensate for the difference in volumetric displacement of the first double chamber volume 86 and the second double chamber volume 90 (the first double chamber volume 86 has less volumetric displacement due to the presence of the coupler 94). Additionally, the first accumulator 26 and the second accumulator 30 absorb any thermal expansion of the hydraulic fluid within the electro-hydraulic actuator 10, avoiding over pressure due to temperature variations.

As shown in FIG. 5, the hydraulic actuator 34 includes a hydraulic actuator housing 106, a rack 110 positioned within the hydraulic actuator housing 106, and a pinion 114 coupled to the coupling 38 (as shown in FIG. 1). The hydraulic actuator housing 106 includes a first hydraulic actuator port 118 in fluid communication with the first double chamber port 98 and the first accumulator 26, and a second hydraulic actuator port 122 in fluid communication with the second double chamber port 102 and the second accumulator 30. The rack 110 includes a first rack piston 126 sealed to the hydraulic actuator housing 106 by a first rack seal 130 that defines a first hydraulic actuator volume 134 in fluid communication with the first double chamber volume 86. The rack 110 also includes a second rack piston 138 sealed to the hydraulic actuator housing 106 by a second rack seal 142 that defines a second hydraulic actuator volume 146 in fluid communication with the second double chamber volume 90. The pinion 114 is coupled to the rack 110 so that linear movement of the rack 110 is converted to rotary movement of the pinion 114 and in turn the coupling 38. Each of the first hydraulic actuator volume 134 and the second hydraulic actuator volume 146 defines a relative size that changes depending on the position of the rack 110 within the hydraulic actuator housing 106.

As shown in FIG. 4, a size of and a related volume of hydraulic fluid within the first double chamber volume 86 is inversely proportional to a size of and a related volume of hydraulic fluid within the first hydraulic actuator volume 134, and also inversely proportional to a size of and a related volume of hydraulic fluid within the second double chamber volume 90. Likewise, a size of and a related volume of hydraulic fluid within the second double chamber volume 90 is inversely proportional to a size of and a related volume of hydraulic fluid within the second hydraulic actuator volume 146, and also inversely proportional to a size of and a related volume of hydraulic fluid within the first double chamber volume 86.

The valve 14 may be a quarter turn valve such as a ball valve or a butterfly valve, for example, that includes an input shaft 150 coupled to the pinion 114 via the coupling 38. Actuation of the electro-hydraulic actuator 10 rotates the input shaft 150 so that the valve 14 can be actuated between opened or closed positions.

Operation of the electro-hydraulic actuator 10 and the associated valve 14 will be discussed below with reference to FIG. 4. Communication with the controller 50 can be provided via a network connected to the controller via the terminal connection 54 or via a wireless device such as a PDA using Bluetooth™ connectivity. The system can operate using Foundation Fieldbus protocol. The controller 50 receives communication from external sources (e.g., the network or a wireless device) and can be programmed to operate independently. For example, the controller 50 can communication with one or more sensors including valve position sensors, pressure sensors, torque sensors, or temperature sensors connected to the valve 14 or the electro-hydraulic actuator 10, for example, and operate the valve 14 to maintain a desired condition (e.g., an open position, a closed position, a position between the open position and the closed position, a modulated position, etc.).

When the controller 50 determines that the state of the valve 14 should be changed, whether from external communication or internal programming, power is supplied to the electric motor 42 and the reciprocating ball nut 66 is rotated so that the threaded shaft 62 moves linearly. For example, when the reciprocation ball nut 66 is rotated clockwise, the threaded shaft 62 extends from the electric actuator 18 and the double chamber piston 78 moves to increase the amount of hydraulic fluid held within the first double chamber volume 86 and to reduce the amount held within the second double chamber volume 90. In turn, the pressure in the first hydraulic actuator volume 134 decreases, and the pressure in the second hydraulic actuator chamber 146 increases. The pressure differential moves the rack 110 toward the first hydraulic actuator volume 134 (e.g., to the right in FIG. 5) so that the pinion 114 rotates the coupling 38, and in turn the valve input shaft 150.

When the reciprocation ball nut 66 is rotated counter-clockwise, the threaded shaft 62 retracts into the electric actuator 18 and the double chamber piston 78 moves to decrease the amount of hydraulic fluid held within the first double chamber volume 86 and to increase the amount held within the second double chamber volume 90. In turn, the pressure in the first hydraulic actuator volume 134 increases, and the pressure in the second hydraulic actuator chamber 146 decreases. The pressure differential moves the rack 110 toward the second hydraulic actuator volume 146 (e.g., to the left in FIG. 5) so that the pinion 114 rotates the coupling 38, and in turn the valve input shaft 150.

The accumulators 26, 30 act to absorb volumetric displacement and thermally induced changes within the system. For example, at higher temperatures, the pressure of the hydraulic fluid increases and the accumulators 26, 30 need to relieve pressure. At lower temperatures, pressure is decreased and the accumulators 26, 30 need to add pressure to the system.

The electro-hydraulic actuator 10 provides a closed hydraulic system that does not require a pump or solenoid controlled hydraulic flow/control (e.g., using flow regulators, solenoid operated pressure valves, control systems, etc.). Additionally, the system does not require relief valves or stop valves. A closed system presents less risk of leakage and failure due to power loss or insufficient maintenance. Since the system does not include a pump, relative sea level does not affect the performance of the system. Another advantage of the closed system design is that the electro-hydraulic actuator 10 can be installed in areas where there may not be sufficient power to operate a pump.

The electro-hydraulic actuator 10 is a fail-in-last-position type actuator. In other words, hydraulic fluid and pressure are always maintained in both the first hydraulic actuator volume 134 and the second hydraulic actuator volume 146 so that the rack 110 is effectively locked in place.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. An electro-hydraulic actuator for actuating a valve, the electro-hydraulic actuator comprising:
an electric linear actuator including an electric motor and a controller controlling the electric motor;
a double chamber hydraulic cylinder including a double chamber piston coupled to the electric linear actuator, and defining a first double chamber volume and a second double chamber volume, a position of the double chamber piston affecting relative sizes of the first double chamber volume and the second double chamber volume; and
a hydraulic actuator including a hydraulic actuator housing, a first rack piston, a second rack piston, a rack arranged between the first rack piston and the second rack piston, and a pinion engaged with the rack, a first hydraulic actuator volume being defined between the hydraulic actuator housing and the first rack piston and being in communication with the first double chamber volume, and a second hydraulic actuator volume being defined between the hydraulic actuator housing and the second rack piston and being in communication with the second double chamber volume.

2. The electro-hydraulic actuator of claim 1, wherein the electric linear actuator includes a power screw assembly.

3. The electro-hydraulic actuator of claim 2, wherein the power screw assembly includes a recirculating ball nut and a threaded rod.

4. The electro-hydraulic actuator of claim 1, wherein the controller includes a user interface and provides wireless communication.

5. The electro-hydraulic actuator of claim 1, wherein the controller communicates using Foundation Fieldbus protocol.

6. The electro-hydraulic actuator of claim 1, and further comprising a first accumulator, and a second accumulator.

7. The electro-hydraulic actuator of claim 6, wherein the first accumulator and the second accumulator are bladder type accumulators.

8. The electro-hydraulic actuator of claim 6, wherein the first accumulator is arranged in fluid communication with the first double chamber volume, and the second accumulator is arranged in fluid communication with the second double chamber volume.

9. The electro-hydraulic actuator of claim 6, wherein the first accumulator is arranged in fluid communication with the first hydraulic actuator volume, and the second accumulator is arranged in fluid communication with the second hydraulic actuator volume.

10. The electro-hydraulic actuator of claim 6, wherein the first accumulator is arranged between the first double chamber volume and the first hydraulic actuator volume, and the second accumulator is arranged between the second double chamber volume and the second hydraulic actuator volume.

11. The electro-hydraulic actuator of claim 1, wherein the double chamber hydraulic cylinder and the hydraulic actuator form a closed hydraulic circuit.

12. The electro-hydraulic actuator of claim 1, wherein a first size of the first double chamber volume and a second size of the second double chamber volume are inversely proportional.

13. The electro-hydraulic actuator of claim 1, wherein a first size of the first double chamber volume and a second size of the first hydraulic actuator volume are inversely proportional.

14. The electro-hydraulic actuator of claim 1, wherein a first size of the second double chamber volume and a second size of the second hydraulic actuator volume are inversely proportional.

15. The electro-hydraulic actuator of claim 1, and further comprising a coupling attached to the pinion and configured to engage the valve.

16. A valve and actuator system comprising:
a valve including a quarter turn valve element moveable between an open position and a closed position; and
an electro-hydraulic actuator including an electric linear actuator,
a double chamber hydraulic cylinder including a double chamber piston coupled to the electric linear actuator, and
a hydraulic actuator including a hydraulic actuator housing, a first rack piston, a second rack piston, a rack arranged between the first rack piston and the second rack piston, and a pinion engaged with the rack,
wherein movement of the double chamber piston actuates the hydraulic actuator, and
wherein the pinion is coupled to the valve to actuate the quarter turn valve element between the open position and the closed position.

17. A method of operating a valve with an electro-hydraulic actuator, the method comprising:
controlling an electric motor with the controller;
moving a linear actuator with the electric motor;
moving a double chamber piston with the linear actuator;
moving a rack with hydraulic fluid moved by the double chamber piston;
rotating a pinion with the rack; and
actuating the valve with the pinion.

18. The method of claim 17, and further comprising absorbing volumetric displacement of the hydraulic fluid moved by the double chamber piston with a first accumulator.

19. The method of claim 17, wherein when the double chamber piston is moved a size of a first double chamber volume changes inversely proportional to a size of a first hydraulic actuator volume.

20. The method of claim 17, wherein when the double chamber piston is moved a size of a first double chamber volume changes inversely proportional to a size of a second double chamber volume.

21. The method of claim 17, and further comprising actuating a recirculating ball nut with the electric motor to move a threaded rod linearly relative to the electric motor.
